(19) United States
(12) Patent Application Publication
(10) Pub. No.: US 2007/0104198 A1
(43) Pub. Date: May 10, 2007

(54) Apparatus and method for providing a high availability network mechanish

(76) Inventors: Kumar Kalluri, Southlake, TX (US); Syed A. Hussain, Chicago, IL (US); Niranjan N. Segal, Arlington, TX (US)

Correspondence Address: MOTOROLA, INC., 1303 EAST ALGONQUIN ROAD, IL01/3RD, SCHAUMBURG, IL, 60196, US

(21) Appl. No.: 11/271,006

(22) Filed: Nov. 10, 2005

(51) Int. Cl. H04L 12/56

(52) U.S. Cl. 370/392; 370/401

(57) ABSTRACT

A high availability network mechanism (100) is provided having a primary node (105) and at least one secondary node (120) utilizing Virtual Router Redundancy Protocol (“VRRP”) compatible redundancy systems. The primary and secondary nodes (105 and 120) are associated with access routers (110 and 130, respectively) that are associated with edge routers (115 and 130, respectively). A virtual IP address is associated with the primary node (105) with a first cost assigned to the primary node (105). The same virtual IP address is associated with the secondary node (120) with a second cost assigned to the secondary node (120). A core IP network (135) utilizing an Open Shortest Path First (“OSPF”) compatible redundancy system is accessible through the edge routers (115 and 130) such that the primary and secondary nodes (105 and 120) advertise the virtual IP address with different costs on the IP network (135).

### TECHNICAL FIELD

This invention relates generally to networks and more specifically to high availability networks.

### BACKGROUND

Many types of networks for sharing and routing information are known. Typically, networks are designed with a group of computers or servers linked together using a common protocol for sending information through the network. A common protocol for linking computers through a network is the Internet Protocol (“IP”). A problem with such networks includes the need to have the networks operating with very little downtime such that information is reliably and quickly transferred within the network. For example, networks for live sharing of information such as communication networks require high reliability both for prompt sending of information and for quickly adjusting to failures within the network. Different protocols have been developed for sharing information within typical IP networks. These protocols have different strengths and weaknesses depending upon the network in which these protocols are applied.

One known protocol is the Virtual Router Redundancy Protocol (“VRRP”). This protocol provides redundancy within a network such that if a given computer fails, the network will not fail. VRRP is typically utilized within a given group of computers such that if a primary computer within the group fails, another computer is automatically designated the primary computer for the group thereby reducing the time necessary to reestablish the group's functionality and/or connection to another computer or network. Such reestablishment of a network is typically called a re-convergence.

Another known protocol is the Open Shortest Path First (“OSPF”) protocol. The OSPF protocol is typically implemented within networks where multiple paths for sharing or sending information are available. The OSPF operates by determining the cheapest route through the network for transmitting information, based on the number of resources used to transmit the information. A network using OSPF periodically recalculates the costs for sending information between various computers, servers, or nods within the network such that when information needs to be sent, the lowest cost route is typically readily known and utilized. If a computer or server within a network utilizing OSPF fails, the network would recognize this and re-determine the lowest cost routes for sending information, thereby establishing re-convergence of the network. Given the different types of networks within which OSPF and VRRP typically operate, it is difficult to achieve the benefits of both protocol types.

### BRIEF DESCRIPTION OF THE DRAWINGS

The above needs are at least partially met through provision of the apparatus and method for providing a high availability network mechanism described in the following detailed description, particularly when studied in conjunction with the drawings, wherein:

FIG. 1 is a block diagram as configured in accordance with various embodiments of the invention; and

FIG. 2 is a flow chart as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a high availability network mechanism is provided with a primary node utilizing a VRRP compatible redundancy system and a secondary node utilizing a VRRP compatible redundancy system. The primary node and secondary node access a core IP network through first and second edge routers such that a virtual IP address is associated with both the primary node and the secondary node with a first cost assigned to the primary node and a second cost assigned to the secondary node. The core IP network utilizes an OSPF compatible redundancy system for managing the routing of information through the network.

So configured, the high availability network gains the redundancy advantages of VRRP within the nodes of the network in addition to the redundancy advantages of OSPF in the overall network. By combining the advantages of the two redundancy systems, the network can achieve re-convergence very quickly in the event of local failure of the primary computer within a node and in the event of a catastrophic failure of an entire node. Further, because VRRP and OSPF are both standards compliant protocols, the invention may be applied without excessive effort to bring the network up to applicable standards.

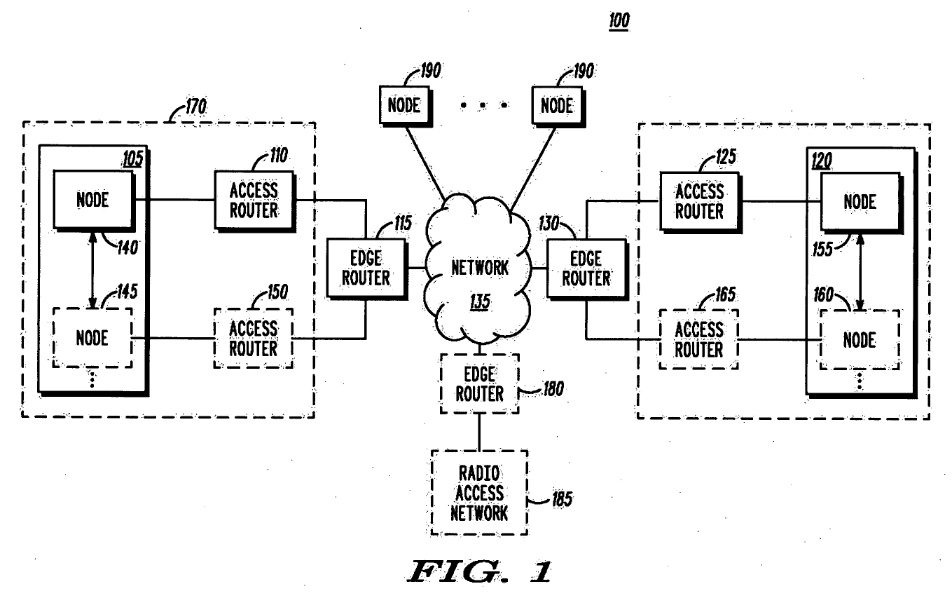

Referring now to the drawings, and in particular to FIG. 1, a high availability network mechanism 100 includes a primary node 105 utilizing a VRRP compatible redundancy system. A node is typically one or more computers having a single access to a network. The primary node 105 is associated with at least one first access router 110 with a unique physical IP address. The first access router 110 is associated with a first edge router 115. A secondary node 120 also utilizes a VRRP compatible redundancy system and is associated with at least one second access router 125. A second edge router 130 is associated with the secondary node 120. A core IP network 135 is accessible through the first edge router 115 and the second edge router 130.

A virtual IP address is associated with the primary node 105 and has a first cost assigned to the primary node 105. The same virtual IP address is associated with the secondary node 120 and has a second cost assigned to the secondary node 120. The core IP network 135 then uses the virtual IP address within an OSPF compatible redundancy system within the network 135.

In an alternative embodiment, the primary node 105 includes a plurality of sub-nodes 140 and 145. Typically, each sub-node 145 will be associated with a separate first access router 150 with a different unique physical IP address such that one sub-node 140 and its first access router 110 will have a different physical IP address from another sub-node 145 and its first access router 150.

Similarly, the secondary node 120 may include a plurality of sub-nodes 155 and 160. Typically, each sub-node 160 will be associated with a separate first access router 165 with a different unique physical IP address such that one sub-node 155 and its second access router 125 will have a different physical IP address from another sub-node 160 and its second access router 165.Typically, each access router for a node will be associated with the edge router for that node. Thus, the first access routers 110 and 150 are associated with the first edge router 115, and the second access routers 125 and 165 are associated with the second edge router 130. With this configuration, the same virtual IP address can apply to the entire primary node sub-system including for example the primary node's access routers, collectively designated as reference numeral 170, and to the entire secondary node sub-system including for example its access routers, collectively designated as reference numeral 175, despite the various physical IP addresses used by the various access routers.

One should note that in the typical hierarchical arrangement of the network, then, the nodes 105, 120, and 190 each utilize a VRRP compatible redundancy system such that the VRRP compatible configure compensates for failures within a node 105, 120, or 190. At the higher level, within the IP network 135, an OSPF compatible redundancy system operates to compensate for total failures of a primary node 105. In other words, the combination and hierarchy can be arranged as nodes that are part of two or more autonomous systems. The VRRP compatible redundancy system can be configured between sub-nodes within a node 105, 120, or 190 that will use a default gateway redundantly to one or more autonomous systems to provide reachability to an external network such as the IP network 135. The OSPF compatible redundancy system will be configured as the transport routing protocol on access routers and all core external edge routers that will convey information about the highly available IP addresses and corresponding functionalities. Thus, in terms of configuration hierarchy, end nodes that are part of a single LAN within a geographical area can be setup to run a VRRP compatible redundancy system and the rest of the network that includes devices/routers with multiple LAN segments or subnets can be configured to run OSPF. Thus, the VRRP and OSPF compatible redundancy systems operate together at different hierarchical portions of the overall network to provide increased redundancy for the overall network.

Therefore, within each node 105 or 120, the plurality of sub-nodes 140 and 145 or 155 and 160 provides n+1 redundancy within the nodes 105 and 120 through the application of the VRRP compatible redundancy system. Thus, should the main sub-node 140 for the primary node 105 fail, sub-node 145 automatically assumes the connection for the node 105. Typically, when the primary node 105 experiences such a single failure, the primary node 105 will achieve re-convergence within less than about 20 milliseconds. Such a re-convergence time is determined based upon typical re-convergence times for VRRP only based networks. Typically, a VRRP compatible redundancy system also has a “Master Down Interval” time that forces re-convergence in the order of about 1 second. There are certain known system configurations also available that affect the re-convergence times to some extent, but the integration of physical link detect type mechanisms significantly reduce detect times so that the re-convergence in the VRRP compatible redundancy system is triggered immediately without having to wait for the typical interval to expire thereby achieving re-convergence times of less than about 20 milliseconds.

Further, the OSPF compatible redundancy system used within the core IP network 135 provides an n+1 redundancy for the primary node sub-system 170 where each secondary node sub-system 175 associated with the primary node sub-system's 170 virtual IP address provides that redundancy. Such redundancy among the nodes' sub-systems 170 and 175 allows for protection against a catastrophic failure of an entire node or node sub-system such as failure of a node's access or edge routers. For example, a typical high availability network mechanism 100 can be applied on a large geographic scale where the primary node sub-system 170 can be located in Los Angeles and the secondary node sub-system 175 can be located in Atlanta. Another edge router 180 may provide access to the core IP network 135 for another node such as a radio access network 185 located in Phoenix.

Typically, the radio access network 185 in Phoenix is more likely to receive its data from the primary node sub-system 170 in Los Angeles because the cost to receive such data through the IP network 135 from the primary node sub-system 170 will typically be less than the cost to receive such data from the secondary node sub-system 175 in Atlanta. Should the primary node sub-system 170 in Los Angeles experience a catastrophic failure, such as in the event of an earthquake, the radio access network 185 in Phoenix will be able to receive data from the secondary node sub-system 175 in Atlanta because the OSPF redundancy system in the IP network 135 will reset the cost for the primary node sub-system 170 to indicate that the node is offline. Then, the IP network 135 will recognize the virtual IP address and smallest cost as that of the secondary node sub-system 175 in Atlanta and reroute all information to the radio access network 185 through the secondary node sub-system 175. Usually, such re-convergence of the high availability network mechanism upon a catastrophic failure of the primary node sub-system 170 occurs in less than about 45 seconds.

Such a re-convergence time is determined based upon typical re-convergence times for OSPF only based networks. Typically, the OSPF protocol depends upon a “router dead interval” to detect and trigger re-convergence in a network. The overall re-convergence time is dependent upon the size and number of routers in the network, but typically this is typically less than about 45 seconds and more often in the order of about 20 to 30 seconds. There are certain known system configurations also available that affect the re-convergence times to some extent, but the integration of physical link detect type mechanisms and fast-LSA (“Link State Algorithm”) techniques significantly reduce detect times so that the re-convergence in the OSPF compatible redundancy system can be achieved in less than about 10 seconds.

In certain embodiments, the virtual IP address can be adapted to various specific uses. For example, in a given system a virtual IP address may be associated with a given functionality. Such functionalities may include transferring voice data, transferring text messaging data, signaling and associated control data for call processing applications, or other such functionalities. Similarly, the virtual IP address may be associated with a given application. For example, a single virtual IP address may be exclusively identified with a particular gaming application, paging applications, and applications to provide on-demand network level statistics, network control, and traffic engineering. These associations between functionality or application and virtual IP address allow for easier maintenance and managing of the network and easier creation of the proper redundancy for certain applications or functionalities.

In one such embodiment, the high availability network mechanism may include a plurality of virtual IP addresses assigned to the secondary node 120 wherein each virtual IP address is associated with one of a plurality of primary nodes 105 and 190. In this alternative, the secondary node 120 may be a redundant backup for any number of primary nodes 105. Each primary node 105, therefore, may be associated with a different functionality or application, and the secondary node 120 may operate as a redundant backup for all those functionalities or applications. In accordance with this embodiment, each virtual IP address assigned to the secondary node 120 will have an associated second cost that is typically higher than the first cost associated with the primary node 105 for that virtual IP address. Thus, in this embodiment, the secondary node 120 provides geographical redundancy for multiple different functionality groups of primary nodes 105.

Alternatively, a single primary node 105 may have a plurality of secondary nodes 120 and 190 that are assigned the primary node's 105 virtual IP address and with second costs associated with the secondary nodes 120. In this embodiment, the primary node 105 has multiple redundant backup nodes 120 and 190. The second costs may be assigned to the secondary nodes 120 and 190 automatically or set by a network administrator to create a priority among the backup secondary nodes 120 and 190. Thus, one should note that using the same virtual address for multiple nodes with different costs for each node within the network using the OSPF compatible redundancy system provides flexibility in the design of the network and significant advances in the recovery of the network in the event of node failure.

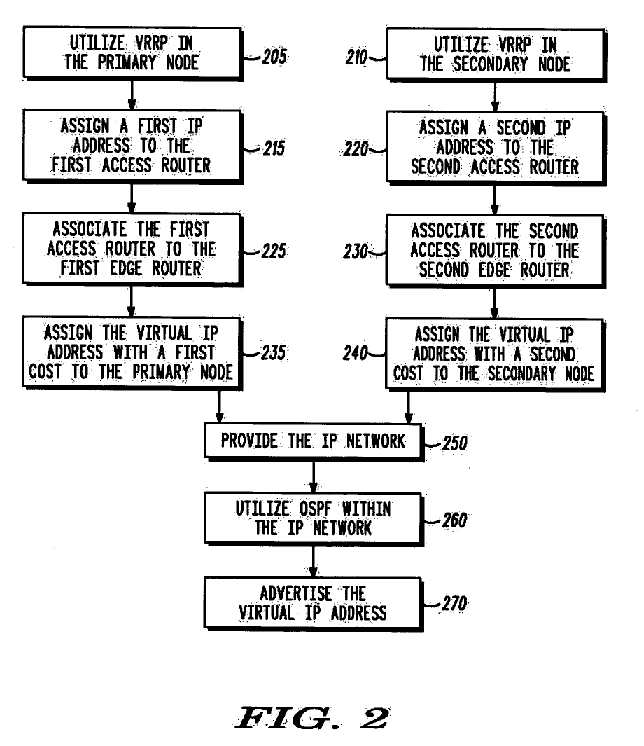

A method of providing a high availability network mechanism will be discussed with reference to FIG. 2. Starting with the nodes, one utilizes 205 a VRRP compatible redundancy system within the primary node 105 and utilizes 210 a VRRP compatible redundancy system within the secondary node 120. A first unique physical IP address is assigned 215 to a first access router 110 associated with the primary node 105, and a second unique physical IP address is assigned 220 to a second access router 125 associated with the secondary node 120. The first access router 110 is associated 225 with the first edge router 115, and the second access router 125 is associated 230 with the second edge router 130. A virtual IP address with a first cost is assigned 235 to the primary node 105. Similarly, the virtual IP address assigned to the primary node 105 is assigned 240 to the secondary node 120 but with a second cost.

Typically, each cost is assigned by automatically assigning the costs based upon a provided decision process algorithm. For instance, it is common for a network using OSPF to include an internally operated algorithm that periodically detects the system costs for routing information between given nodes. Costs can be assigned based upon path preference, bandwidth availability, node reliability, or any of several other known pre-determined factors. Once the cost has been assigned to a virtual IP address, when the virtual IP address is learned by the network, the cost associated is also inherently learned. Thus, because the typical routing database for the IP network includes multiple routes to a given network functionality or application, the IP network essentially immediately knows what the next best path is when one of the nodes goes down and uses that next best path to achieve higher availability. Such algorithms or similar readily developed algorithms may determine and assign the costs to the primary node 105 and secondary node 120. Alternatively, a network administrator may preset the costs so as to determine the hierarchy of the nodes within the OSPF compatible redundancy system.

Similarly, assigning 235 and 240 the virtual IP address typically includes automatically assigning the virtual IP address based upon a provided software algorithm. The software algorithm is typically an algorithm built within the network 135 running the OSPF compatible redundancy system such that once a network administrator sets that a particular node should be assigned a virtual IP address, the software based network algorithm sets the IP address automatically. Alternatively, the network administrator may preset the virtual IP addresses for the nodes of the network.

In a further alternative, the virtual IP address may be assigned to a given functionality or a given application. Such an assignment is usually done by a network administrator either by specifically assigning a virtual IP address to a given functionality or application or by designating within the network 135 that a given functionality or application is to assigned a particular virtual IP address.

In an alternative to assigning 240 the virtual IP address to the secondary node 120, a plurality of virtual IP addresses may be assigned to the secondary node 120 wherein each virtual IP address is associated with one of a plurality of primary nodes 105 and 190. In this alternative, each virtual IP address has an associated second cost that is associated with the secondary node 120.

With continuing reference to FIG. 2, a core IP network 135 is provided 250 that is accessible through the first edge router 115 and the second edge router 130. Further, an OSPF compatible redundancy system is utilized 260 within the core IP network 135. The virtual IP address is then advertised 270 to the core IP network 135. Advertising an IP address is known within OSPF compatible redundancy systems where a node advertises the IP address for the node to the network for routing and for cost calculating purposes.

In an alternative embodiment, a plurality of nodes is provided wherein each of the plurality of nodes 190 is geographically separate, utilizes a VRRP compatible redundancy system, and is assigned the virtual IP address when the plurality of nodes 190, the primary node 105, and the secondary node 120 share at least the same functionality or the same application. Such a provided larger scale network will usually allow for increased ease in managing the high availability network mechanism 100 where a single virtual IP address is assigned to a given functionality or application.

One skilled the in art will recognize that the various servers, computers, and networking hardware needed to construct such network mechanisms as described herein are known and readily available. One skilled in the art would be able to reconfigure the software controls for these hardware components to implement the systems as described. Further, one will recognize that although VRRP and OSPF are standards based systems, similar or compatible systems or future modifications to these systems would be similarly functional within the described network mechanisms.

So configured, the above described networks provide n+1 redundancy within the nodes of the network and within the individual nodes. Thus, re-convergence times for various failure modes within such a network and within the nodes are typically reduced. Further, because the described networks operate under standards based protocols, implementation typically requires less up front effort and cost. In addition, application or functionality specific addresses provide additional ease in network maintenance and development.

Those skilled in the art will recognize that a wide variety of modifications, alterations, and combinations can be made with respect to the above described embodiments without departing from the spirit and scope of the invention. For example, one skilled in the art will recognize that the above described high availability network mechanism concepts may further be applied larger scale and more complicated networks. Such modifications, alterations, and combinations are to be viewed as being within the ambit of the inventive concept.

We claim:

1. A high availability network mechanism comprising:
a primary node utilizing a Virtual Router Redundancy Protocol (“VRRP”) compatible redundancy system;
at least one first access router with a unique physical Internet Protocol (“IP”) address, the at least one first access router being associated with the primary node;
a first edge router associated with the at least one first access router;
a secondary node utilizing a VRRP compatible redundancy system;
at least one second access router with a physical IP address, the at least one second access router being associated with the secondary node;
a second edge router associated with the at least one second access router;
a virtual IP address that is
associated with the primary node and having a first cost assigned to the primary node; and
associated with the secondary node and having a second cost assigned to the secondary node;
a core IP network accessible through the first edge router and the second edge router, the core IP network using the virtual IP address within an Open Shortest Path First (“OSPF”) compatible redundancy system.

2. The high availability network mechanism of claim 1 wherein each first access router is associated with a different unique physical IP address.

3. The high availability network mechanism of claim 1 wherein each second access router is associated with a different unique physical IP address.

4. The high availability network mechanism of claim 1 wherein the primary node further comprises a plurality of sub-nodes.

5. The high availability network mechanism of claim 1 wherein the secondary node further comprises a plurality of sub-nodes.

6. The high availability network mechanism of claim 1 wherein the primary node and the secondary node are located in geographically remote areas.

7. The high availability network mechanism of claim 1 wherein the virtual IP address is associated with at least one of the group comprising a given functionality, and a given application.

8. The high availability network mechanism of claim 1 wherein the virtual IP address is associated with a plurality of secondary nodes and having second costs assigned to each of the plurality of secondary nodes.

9. The high availability network mechanism of claim 1 wherein the primary node achieves re-convergence upon a single failure within the primary node in less than about 20 milliseconds and the high availability network mechanism achieves re-convergence upon a catastrophic failure of the entire primary node in less than about 45 seconds.

10. The high availability network mechanism of claim 1 further comprising a plurality of virtual IP addresses, each virtual IP address having an associated second cost, assigned to the secondary node wherein each virtual IP address is associated with one of a plurality of primary nodes.

11. A method of providing a network with local and geographic redundancy comprising:
utilizing a Virtual Router Redundancy Protocol (“VRRP”) compatible redundancy system within a primary node;
assigning a first unique physical Internet Protocol (“IP”) address to a first access router associated with the primary node;
associating a first edge router with the first access router;
utilizing a VRRP compatible redundancy system within a secondary node;
assigning a second unique physical IP address to a second access router associated with the secondary node;
associating a second edge router with the second access router;
assigning a virtual IP address with a first cost to the primary node;
assigning the virtual IP address with a second cost to the secondary node;
providing a core IP network accessible through the first edge router and the second edge router;
utilizing an Open Shortest Path First (“OSPF”) compatible redundancy system within the core IP network; and
advertising the virtual IP address to the core IP network.

12. The method of claim 11 wherein assigning the first cost to the primary node further comprises automatically assigning the first cost based upon a provided decision process algorithm.

13. The method of claim 11 wherein assigning the second cost to the secondary node further comprises automatically assigning the second cost based upon a provided software algorithm.

14. The method of claim 11 wherein assigning the virtual IP address further comprises automatically assigning the virtual IP address based upon a provided software algorithm.

15. The method of claim 11 further comprising assigning the virtual IP address to one of the group comprising a given functionality, and a given application.

16. The method of claim 11 further comprising assigning a plurality of virtual IP addresses, each virtual IP address having an associated second cost, to the secondary node wherein each virtual IP address is associated with one of a plurality of primary nodes.

17. The method of claim 11 further comprising: providing a plurality of nodes wherein each of the plurality of nodes is geographically separate, utilizes a VRRP compatible redundancy system, can access the core IP network, and is assigned the virtual IP address when the plurality of nodes, the primary node, and the secondary node share at least one of the group comprising the same functionality, and the same application.

18. A network comprising:
means for providing at least a first node and a second node, each node utilizing a Virtual Router Redundancy Protocol (“VRRP”) compatible redundancy system;
means for connecting the nodes to a core network, wherein the core network utilizes an Open Shortest Path First (“OSPF”) compatible redundancy system;
means for assigning a virtual Internet Protocol (“IP”) address to the nodes;
means for assigning a cost to each node;
means for advertising the virtual IP address and each cost to the core network.

19. The network of claim 18 wherein the nodes all perform a similar functionality corresponding to the virtual IP address.

20. The network of claim 18 wherein the nodes all perform a similar application.
